(19) United States
(12) Patent Application Publication
(10) Pub. No.: US 2026/0215408 A1
(43) Pub. Date: Jul. 30, 2026

(54) THERAPEUTIC HORSESHOE AND METHOD FOR TREATMENT OF LAMINITIS OR FOUNDER

(71) Applicant: David ADAM-CASTRILLO, New Hope, PA (US)

(72) Inventor: David ADAM-CASTRILLO, New Hope, PA (US)

(21) Appl. No.: 19/461,698

(22) Filed: Jan. 27, 2026

Related U.S. Application Data
(60) Provisional application No. 63/750,082, filed on Jan. 27, 2025.

(51) Int. Cl. A01L 15/00; A01L 1/04

(52) U.S. Cl. CPC A01L 15/00; A01L 1/04

(57) ABSTRACT

A therapeutic horseshoe is configured to be mounted on a hoof of a horse for treating laminitis of the hoof. The therapeutic horseshoe includes a shoe rail configured to be secured to the hoof; a compression plate configured to engage a frog portion of the hoof; and a biasing element disposed to urge the compression plate to exert pressure on the frog portion of the hoof.

### CROSS REFERENCE TO RELATED APPLICATIONS

This application claims the benefit of priority under 35 USC §119(e) of U.S. Provisional Ser. No. 63/750,082 filed Jan. 27, 2205, the contents of which are incorporated herein by reference.

### BACKGROUND OF THE DISCLOSURE

Laminitis, also known as founder, is a condition in which laminae in the hoof of a horse become inflamed. The laminae, which attach the hoof of the horse to the distal (third) phalanx (“coffin”) bone found in the horse's lower leg, may become damaged and may detach from the coffin bone. This condition can lead to permanent damage of the hoof. Permanent damage to the hoof may lead to permanent lameness of the horse.

The lamina is an extensive folding arrangement which allows an increased contact area between the soft tissue covering the third phalanx (coffin bone) and the surrounding hoof. The weight of the horse is normally suspended from the underside of the hoof wall by means of the lamina. The bottom of the hoof only supports some of this great force or load. The hoof has a large contact-surface area that helps to support and distribute the forces imposed by the weight and movement of the horse.

During laminitis, the laminar attachment connecting the hoof and the bone weakens and frequently eventually fails, leading to a loss of holding power which allows for the movement of the bone towards the ground. With bone rotation of the third phalanx, the central part of the laminar attachment fails while the areas of the side of the hoof remain attached, resulting in an uneven movement of the third phalanx, where the tip of the bone turns away from the hoof wall and towards the ground, as seen in the attached FIG. 9 and as discussed in further detail below. Due to a lack of laminar support the weight on the hoof is greatly shifted to the bottom structures, including the sole and the frog. The soft tissue under the sole is abnormally compressed and quickly becomes necrotic. At the same time movement of the bone within the hoof capsule distorts the space at the coronary band, creating pressure necrosis of the hoof-producing tissue there. The end result is a self-reinforcing cycle of inflammation and progressive destruction of the soft tissues that produce and support the hoof.

There are different stages of horses suffering from laminitis. If the inflammation of the lamina is very transient and the horses are promptly treated and supported, movement of the hoof capsule (including displacement of the distal (third) phalanx) may never occur and the horses can fully recover. On the other hand, if the laminar inflammation is severe and prolonged, then separation of the laminar bond occurs and the self-reinforcing cycle of more inflammation and more soft tissue destruction occurs. This process often results in severe pain for the horse and potentially unbearable suffering, either of which may eventually make it necessary to euthanize the horse.

Treatment for laminitis involves medical and supportive therapies. Supportive therapies mainly focus on shifting the weight to the caudal (heel) part of the hoof where there is still some laminar attachment and to decrease the tension created by the deep digital flexor tendon. This may be accomplished by applying a wedge or other sloped support to the foot of the horse, so that the rear of the foot is higher than the front of the foot. Pressure can be applied to the bottom of the hoof via the frog. The frog and the soft tissue under it, the digital cushion, are specialized structures to reduce the impact during landing under normal conditions. If there is enough support for the third phalanx and the cycle of inflammation subsides, then it is possible for the hoof to develop a strong laminar bond again. The degree of recovery will depend on the extent of the ongoing laminar attachment and the new hoof growth.

Referring to FIG. 9, an X-ray (radiograph) depicts movement of the third phalanx (distal phalanx/coffin bone) in relation to the hoof capsule (rotation). The distal end of the bone has become closer to the ground. Rotation occurs when there is loss of attachment of the hoof around the front part of the circumference of the bone. The weight of the horse is normally suspended via a strong laminar attachment and the maximal force is centered on the front part of the hoof. This correlates to the greater thickness of the hoof wall in this region. If the laminar damage is more extensive around the sides of the hoof, then the entire bone will tend to sink towards the ground with less rotation. When the tip of the bone gets closer to the ground, sole pressure increases in a very focal area, resulting in severe inflammation and lameness. Third phalanx rotation also involves abnormal pressure at the coronary band, the area of hoof production, which leads to great inflammation and pain. Rotation of the bone during laminitis commonly results in permanent damage to the hoof.

The present disclosure relates generally to a device and method for the treatment of laminitis or founder in a hoof of a horse. The device comprises a therapeutic horseshoe adapted to apply a force to the foot of the horse, and particularly to sustain sufficient pressure on the frog of the foot of the horse, and even to increase pressure on the frog over time, to aid in healing of the laminitis. A method of treating laminitis in a hoof of a horse includes applying a controlled amount of force to a foot under treatment, including sustaining and/or increasing such force over time. Embodiments of the method may include use of the therapeutic horseshoe disclosed herein.

### BRIEF SUMMARY OF THE DISCLOSURE

Briefly stated, one aspect of the present disclosure is directed to a therapeutic horseshoe configured to be mounted on a hoof of a horse for treating laminitis of the hoof. The therapeutic horseshoe includes a shoe rail configured to be secured to the hoof; a compression plate configured to engage a frog portion of the hoof; and a biasing element disposed to urge the compression plate to exert pressure on the frog portion of the hoof.

Embodiments of a therapeutic horseshoe are described by the following clauses.
Clause 1. A therapeutic horseshoe configured to be mounted on a hoof of a horse for treating laminitis of the hoof, the therapeutic horseshoe comprising: a shoe rail configured to be secured to the hoof; a compression plate configured to engage a frog portion of the hoof; and a biasing element disposed to urge the compression plate to exert pressure on the frog portion of the hoof.
Clause 2. The therapeutic horseshoe of clause 1, further comprising a base having an upper surface configured to face the hoof and a lower surface configured to face opposite the hoof, the base including a plurality of upwardly extending legs.
Clause 3. The therapeutic horseshoe of any preceding clause, wherein the shoe rail is supported by and attached to the upwardly extending legs of the base, the shoe rail including nail holes configured to receive horseshoe nails for securing the therapeutic horseshoe to the hoof.
Clause 4. The therapeutic horseshoe of any preceding clause, wherein the compression plate comprises a centrally extending protrusion configured to support a frog portion of the hoof.
Clause 5. The therapeutic horseshoe of any preceding clause, wherein the centrally extending protrusion is pivotably supported relative to the shoe rail by a shaft attached to the protrusion, the shaft being pivotably attached to the shoe rail.
Clause 6. The therapeutic horseshoe of any preceding clause, wherein the biasing element comprises a resilient member disposed between the centrally extending protrusion and the base to urge the centrally extending protrusion upwardly toward the frog portion of the hoof.
Clause 7. The therapeutic horseshoe of any preceding clause, wherein the resilient member comprises a spring disposed between a lower locator plate and an upper locator plate.
Clause 8. The therapeutic horseshoe of any preceding clause, further comprising an adjustment member engageable to compress the spring to selectively vary a force applied by the centrally extending protrusion to the frog portion of the hoof during treatment of laminitis.
Clause 9. The therapeutic horseshoe of clause 1, further comprising: a front base plate having an upper surface configured to engage an underside of a hoof wall and a lower surface configured to face a ground surface; a rear base plate disposed posteriorly of the front base plate and having an upper surface defining at least a portion of the compression plate and configured to engage the frog portion of the hoof, and a lower surface configured to face the ground surface; and a bridge linking the front base plate to the rear base plate, wherein the shoe rail is secured to the front base plate and the rear base plate and extends between the front base plate and the rear base plate.
Clause 10. The therapeutic horseshoe of clause 9, further comprising: a front support element disposed between the bridge and the front base plate and having a first compressive stiffness; and a rear support element disposed between the bridge and the rear base plate and defining the biasing element, wherein the rear support element has a second compressive stiffness lower than the first compressive stiffness to apply a controlled force to the frog portion of the hoof.
Clause 11. The therapeutic horseshoe of clause 9 or claim 10, wherein: the front support element comprises a pair of tubular steel spacers; and the rear support element comprises at least one spring adjustable in compression to selectively vary the controlled force applied to the frog portion of the hoof during a course of treatment.
Clause 12. The therapeutic horseshoe of any one of clauses 9-11, wherein the rear support element comprises a pair of coil springs, each coil spring being preloaded by an adjustable threaded fastener.
Clause 13. The therapeutic horseshoe of any one of clauses 9-12, wherein the rear base plate includes a centrally extending protrusion configured to support the frog portion of the hoof.
Clause 14. The therapeutic horseshoe of any one of clauses 9-13, further comprising a deformable ground base attached to the lower surface of the rear base plate, the deformable ground base including: a base dish; and a resilient bushing disposed between the base dish and the rear base plate.
Clause 15. The therapeutic horseshoe of any one of clauses 9-14, wherein the bridge includes: a horizontal portion extending parallel to the upper surfaces of the front base plate and the rear base plate; and a transverse backing portion disposed proximally relative to the hoof.

### BRIEF DESCRIPTION OF THE SEVERAL VIEWS OF THE DRAWINGS

The foregoing summary, as well as the following detailed description of at least one preferred embodiment of the therapeutic horseshoe and at least one preferred method for treating laminitis in a horse, will be better understood when read in conjunction with the appended drawings. For the purposes of illustrating the system and method, the drawings show one or more presently preferred embodiments thereof. It should be understood, however, that the application is not limited to the precise arrangements and instrumentalities shown. In the drawings:

FIG. 1 is an upper perspective view of a first example of a therapeutic horseshoe according to the present disclosure;

FIG. 2 is a front perspective view of the therapeutic horseshoe of FIG. 1, along with casting material that may be used in mounting the therapeutic horseshoe on a hoof of a horse;

FIG. 3 is an upper perspective view of the therapeutic horseshoe of FIG. 1, along with casting material that may be used in mounting the therapeutic horseshoe on a hoof of a horse;

FIG. 4 is a lower perspective view of the therapeutic horseshoe of FIG. 1;

FIG. 5 is a side perspective view of a second example of a therapeutic horseshoe according to the present disclosure;

FIG. 6 is an upper perspective view of the therapeutic horseshoe of FIG. 5, along with casting material that may be used in mounting the therapeutic horseshoe on a hoof of a horse;

FIG. 7 is an upper perspective view of the therapeutic horseshoe of FIG. 5, along with casting material that may be used in mounting the therapeutic horseshoe on a hoof of a horse;

FIG. 8 is a lower perspective view of the therapeutic horseshoe of FIG. 5; and

FIG. 9 is an x-ray sectional view of a leg of a horse.

### DETAILED DESCRIPTION OF THE INVENTION

Certain terminology is used in the following description for convenience only and is not limiting. The words “right,” “left,” “lower,” and “upper” designate directions in the drawings to which reference is made. The words “inner” and “outer” refer to directions toward and away from, respectively, the geometric center of an object and designated parts thereof. Unless specifically set forth otherwise herein, the terms “a,” “an,” and “the” are not limited to one element but instead should be read as meaning “at least one.” “At least one” may occasionally be used for clarity or readability, but such use does not change the interpretation of “a,” “an,” and “the.” Moreover, the singular includes the plural, and vice versa, unless the context clearly indicates otherwise. As used herein, the terms “proximal” and “distal” are relative terms referring to locations or elements that are closer to (proximal) or farther from (distal) with respect to other elements, the user, or designated locations. “Including” as used herein means “including but not limited to.” The word “or” is inclusive, so that “A or B” encompasses A and B, A only, and B only. The terms “about,” “approximately,” “generally,” “substantially,” and like terms used herein, when referring to a dimension or characteristic of a component, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit thereof. The terminology set forth in this paragraph includes the words noted above, derivatives thereof, and words of similar import.

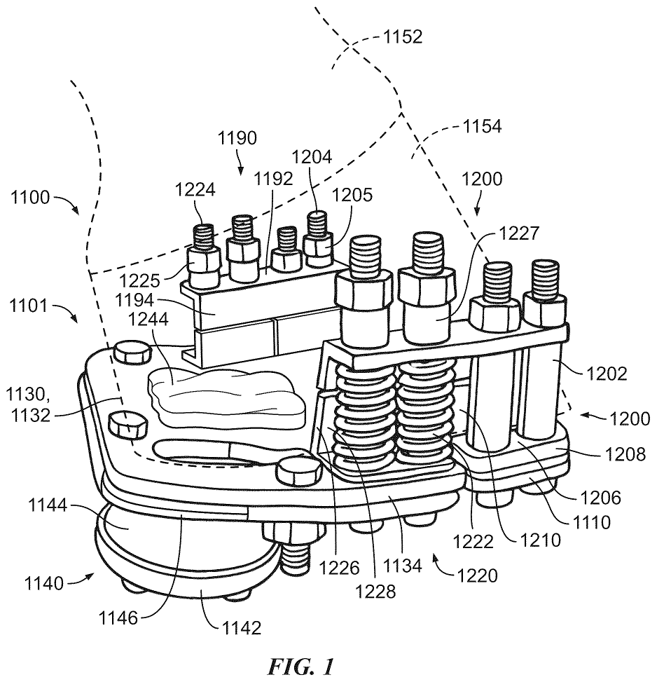

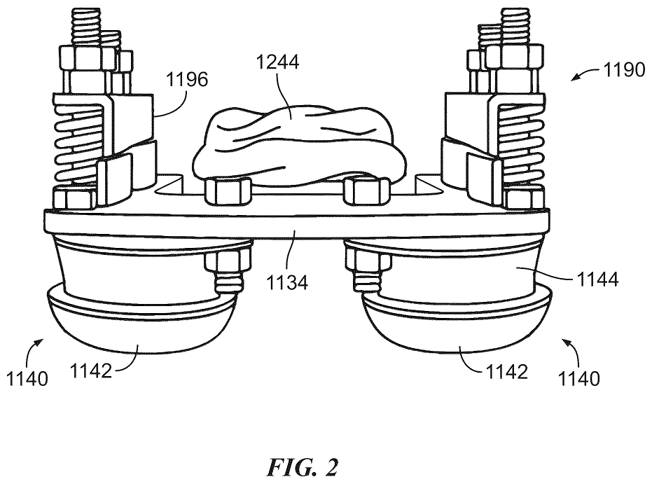

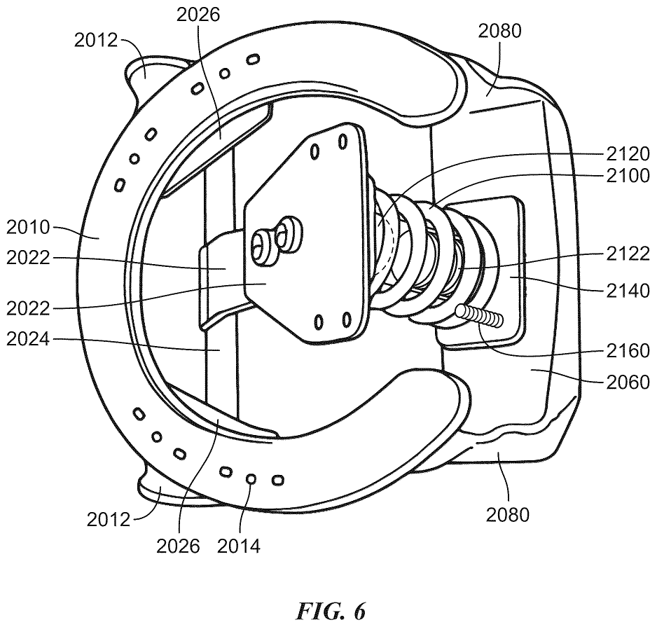

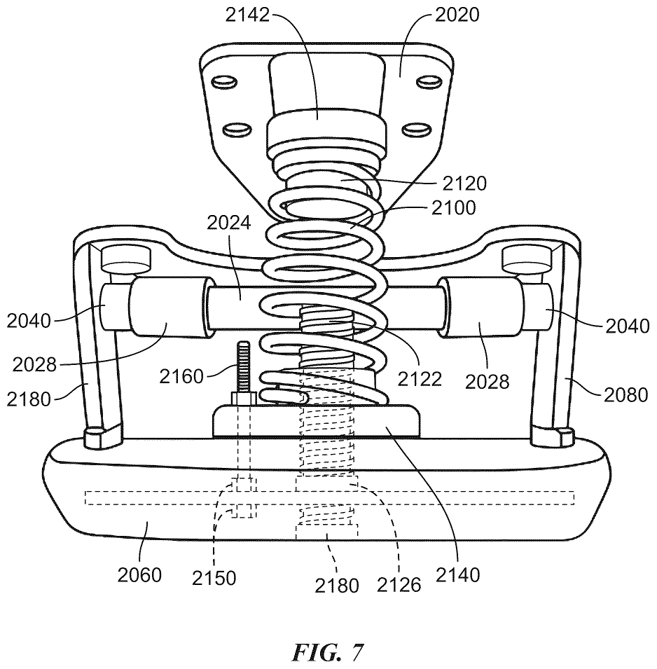

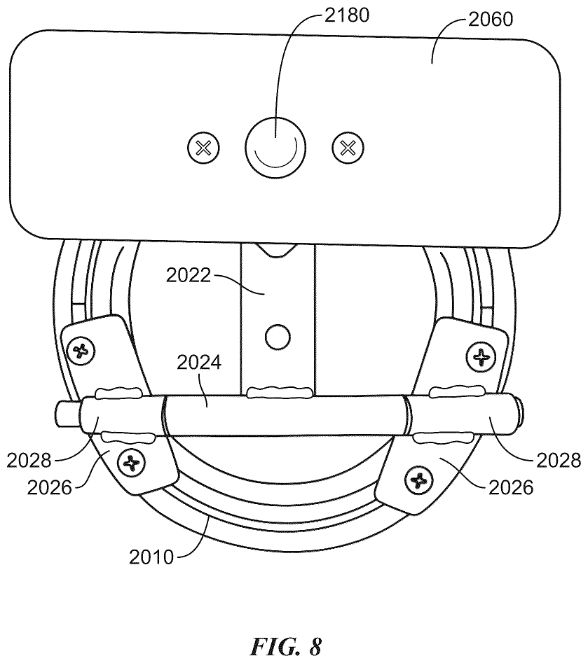

The present disclosure, in one aspect, referring to FIGS. 1-9, is directed to a therapeutic horseshoe 1100 for treatment of laminitis of a hoof 1154 of leg 1152 a horse 1150, and to a second therapeutic horseshoe 2000 for the same purpose.

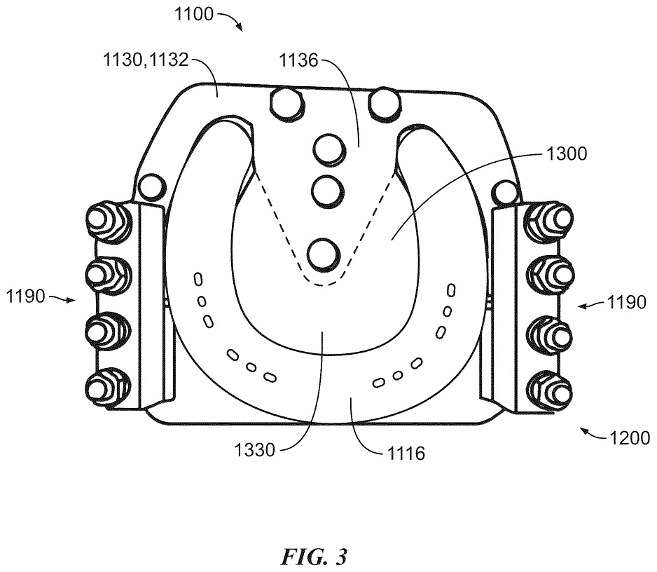

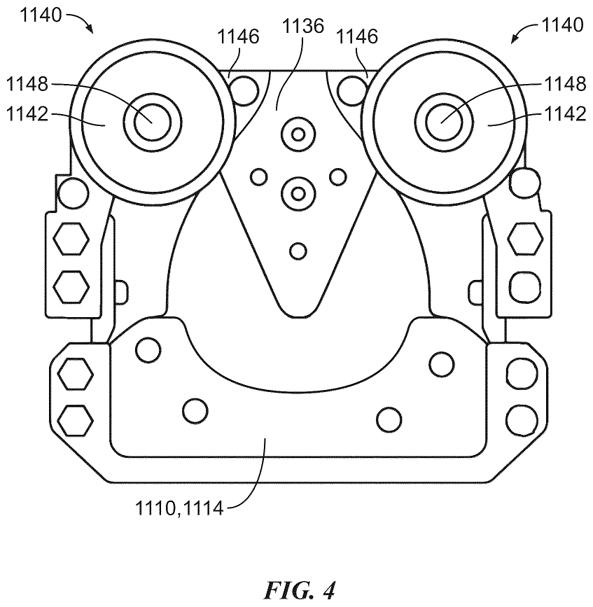

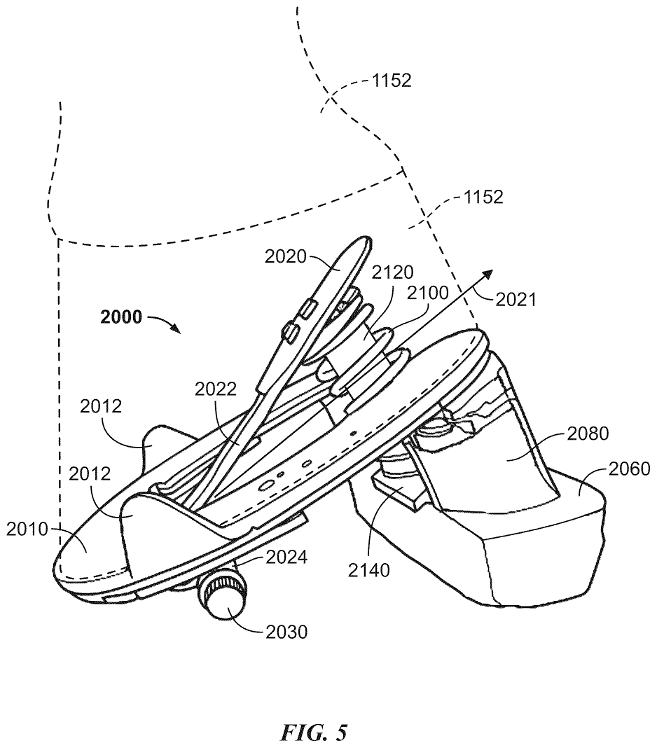

Referring to FIGS. 1-4 and 9, the therapeutic horseshoe 1100 includes a base, which as shown includes a front base plate 1110 and a rear base plate 1130 disposed posteriorly of the front base plate 1110. The front base plate 1110 has an upper surface 1112 (FIG. 5) configured to be oriented toward the hoof 1154 (shown in phantom) toward the ground when the horse is standing, with the hoof 1154 being placed on the upper surface 1112 in a working configuration, as shown in FIG. 1. The upper surface 1112 may include a horseshoe-shaped placement guide (FIG. 3) following the shape of the edge of a hoof 1154 marked or imprinted thereon to aid in aligning the front base plate 1110 for attachment to the hoof 1154. The front plate 1110 may include a cutout 1115 (FIG. 4). The front base plate 1110 includes a lower surface 1114 configured to be oriented away from the hoof 1154, toward the ground when the horse is standing. A shoe rail 1116 (FIG. 3), which in form is comparable to a horseshoe and may be a conventional, commercially available horseshoe of aluminum or other standard or suitable construction, is attached to the upper surface 1112 of the front base plate 1110 and to the upper surface 1132 of the rear base plate 1130. The rear base plate 1130 has a compression plate in the form of a centrally extending protrusion 1136 configured to support a frog portion or other suitable portion of the hoof 1154. A biasing element, here comprising the springs 1222, urges the compression plate (centrally extending protrusion 1136) toward the frog 1156 to exert pressure thereon.

Referring to FIG. 3, the front base plate 1110 has plate apertures 1118, and the shoe rail 1116 has rail apertures (not shown) for aligning with the plate apertures 1118 for permitting horseshoe nails to pass through for attaching the therapeutic horseshoe 1100, including the front base plate 1110, the rear base plate 1130, and the shoe rail 1116, to the hoof 1154. The front base plate 1110 and connected elements are configured to be assembled and connected to the hoof 1154 to anchor, locate, or support the rear base plate 1130 (and elements connected thereto).

The rear base plate 1130 has an upper surface 1132 (FIGS. 1, 3) and a lower surface 1134. The upper surface 1132 may include a placement guide, with the placement guide of the rear base plate being marked or imprinted thereon and suggestive of a desired alignment of the hoof 1154 and/or the shoe rail 1116. Attached to the lower surface 1134 is a deformable rearward ground base 1140, of which two are included in the illustrated example. The deformable rearward ground base 1140 includes a ground-contacting body in the form of base dish 1142 and a resilient body in the form of a bushing 1144, which may be made from a resilient material such as rubber, polyurethane, or other suitably compressible material. The resilient body may take other forms such as a coil spring, air spring, fluid-filled damper, or the like. The resilient body, here the bushing 1144, is disposed between the base dish 1142 and the rear base plate 1130 and deforms when the horse puts weight on the hoof 1154, compressing the resilient body to provide a cushioning effect between the ground and the hoof 1154. The base dish 1142 and the bushing 1144 may be attached to the rear base plate 1130 in any convenient manner, including by a threaded fastener passing through the base dish 1142 and the bushing 1144 as shown. The deformable rearward ground base 1140 may include an upper body 1146, as shown, with the bushing 1144 being disposed between the upper body 1146 and the base dish 1142 on a central shaft 1148. The upper body 1146 may provide apertures for mounting the deformable rearward ground base 1140 to the rear base plate 1130—for example, holes for bolts 1170 and 1224, as shown, of which the bolts 1224 also serve to secure other elements, as discussed below. The deformable rearward ground base 1140 may alternatively take the form of any suitable deformable resilient member, such as any of a variety of commercially available dampers of appropriate resiliency, size, and durability.

A bridge 1190 links the front base plate 1110 to the rear base plate 1130. Preferably a bridge 1190 is provided on each lateral side of the therapeutic horseshoe 1100, as shown. Each bridge 1190 comprises bridge link 1192. The bridge link 1192 extends in spaced relation at least partially above both the front base plate 1110 and the rear base plate 1130. As further described below, a front support element 1200 supports the bridge link 1192 with respect to the front base plate 1110, and a rear support element 1220 supports the bridge link 1192 with respect to the rear base plate 1130.

The front support element 1200 comprises at least one spacer 1202, two of which are shown, disposed between the upper surface 1112 of the front base plate 1110 and the bridge link 1192. Each spacer 1202 is retained in place by a fastener in the form of a bolt 1204 passing through the front base plate 1110 and the bridge link 1192, along with a nut 1205. Each spacer 1202 may be a tubular element selected for appropriate rigidity and stiffness in compression and may be formed from, for example, steel. Each spacer 1202 could alternatively take the form of a spring of high compressive stiffness, so long as the desired relationship is retained between the relative compressive stiffness of each spacer 1202 and other elements of the therapeutic horseshoe 1100. A front transverse link 1206 may locate each spacer 1202 transversely in mutually spaced relation by engaging or capturing and retaining in spaced relation the corresponding bolt 1204. The front transverse link 1206 may be disposed between the upper surface 1112 of the front base plate 1110 and each spacer 1202. The front transverse link 1206 may include both a horizontal portion 1208 extending parallel to the front base plate 1110 and a transverse backing portion 1210 extending transversely to the horizontal portion 1208. The transverse backing portion 1210 may be disposed proximally with respect to each spacer 1202, in a direction toward the hoof 1154 in a mounted configuration. The transverse backing portion 1210 may thus serve as a barrier between the leg 1152 and the hoof 1154 of the horse 1150, on one side of the transverse backing portion 1210, and the front support element 1200, including any movable elements thereof or pinch points between or within the front support element 1200, on an opposite side of the transverse backing portion 1210. The front transverse link 1206 may be formed by, for example, a segment of angle steel and secured by the bolts 1204. Alternatively, the front transverse link 1206 may be integrally formed with the front base plate 1110.

The rear support element 1220 comprises at least one spring 1222, two of which are shown, disposed between the upper surface 1132 of the rear base plate 1130 and the bridge link 1192. Each spring 1222 is retained in place by a fastener in the form of a bolt 1224 passing through the rear base plate 1130 and the bridge link 1192, along with the nut 1225. A spacer 1227 or a washer may be disposed between each nut 1225 and the bridge link 1192. A rear transverse link 1226 may locate each spring 1222 transversely in mutually spaced relation by engaging or capturing and retaining in spaced relation the corresponding bolt 1224. The rear transverse link 1226 may be disposed between the upper surface 1132 of the rear base plate 1130 and each spring 1222. The rear transverse link 1226 may include both a horizontal portion 1228 extending parallel to the rear base plate 1130 and a transverse backing portion 1230 extending transversely to the horizontal portion 1228. The transverse backing portion 1230 may be disposed proximally with respect to each spring 1222, in a direction toward the hoof 1154 in a mounted configuration. The transverse backing portion 1230 may thus serve as a barrier between the leg 1152 and the hoof 1154 of the horse 1150, on one side of the transverse backing portion 1230, and the rear support element 1220, including any movable elements thereof or pinch points between or within such elements, on an opposite side of the transverse backing portion 1230. The rear transverse link 1226 may be formed by, for example, a segment of angle steel and secured by the bolts 1224. Alternatively, the rear transverse link 1226 may be integrally formed with the rear base plate 1130.

The rear support element 1220, here including the combination of the two springs 1222, has a lesser compressive stiffness than the front support element 1200, here including the combination of the two spacers 1202. In the illustrated embodiment, each spring 1222 is a coil spring. The rear support element 1220 could alternatively comprise other types of springs having appropriate strength and stiffness in compression, such as a compressed-gas spring or a solid or tubular element, such as a spacer or body of a resilient material. The springs 1222 provide a cushioning effect between the ground and the hoof 1154.

The arrangement of the bolt 1224, the nut 1225, and the spring 1222 allows for adjustable pre-loading of the spring 1222, and thus for optional adjustment of the compressive stiffness of the rear support element 1220. This provides options for adjusting the compressive stiffness of the rear support element 1220 during a course of treatment for laminitis.

The bridge 1190—specifically the bridge link 1192—extends between and links the front support element 1200 and the rear support element 1220 by engaging or capturing and linking the ends of the bolts 1204 and the bolts 1224. The bridge link 1192 may include a horizontal portion 1194 extending generally parallel to the upper surface 1112 of the front base plate 1110 and generally parallel to the upper surface 1132 of the rear base plate 1130. The bridge link 1192 may also include a transverse backing portion 1196 extending transversely to the horizontal portion 1194. The transverse backing portion 1196 may be disposed proximally with respect to each spring 1222, in a direction toward the hoof 1154 in a mounted configuration. The transverse backing portion 1196 may thus serve as a barrier between the leg 1152 and the hoof 1154 of the horse 1150, on one side of the transverse backing portion 1196, and the front support element 1200 and the rear support element 1220, including any movable elements thereof or pinch points between or within such elements, on an opposite side of the transverse backing portion 1196. The bridge link 1192 may be formed by, for example, a segment of angle steel and may be secured by bolts 1204, nuts 1205, bolts 1224, and nuts 1225.

The therapeutic horseshoe 1100 may include may further include an auxiliary tying plate 1300. The auxiliary tying plate 1300 may extend between the front base plate 1110 and the rear base plate 1130 and may be fastened to each of the front base plate 1110 and the rear base plate 1130. The auxiliary tying plate 1300 may optionally engage the rear base plate 1130 from above the 1132 thereof, while engaging the front base plate 1110 from below the lower surface 1114 thereof. The auxiliary tying plate 1300 further may be configured to support the hoof 1154 and may in particular be configured to support the frog 1156 of the hoof 1154. The auxiliary tying plate 1300 may be attached to the rear base plate 1130 by being attached to the centrally extending protrusion 1136 via bolts or other fasteners or by other fastening methods. Further, the auxiliary tying plate 1300 may be attached to the front base plate 1110 by bolts or other fasteners or by other fastening methods.

The present disclosure, in another aspect, referring to FIGS. 5-9, is directed to a second therapeutic horseshoe 2000 for treatment of laminitis of a hoof 1154 of leg 1152 a horse 1150. As shown, the therapeutic horseshoe 2000 includes a base 2060, which as shown includes upwardly extending legs 2080. In use, the centrally extending protrusion 2020 is aligned rearwardly with respect to the hoof 1154 of the 1150. The base 2060 has an upper surface configured to be oriented toward the hoof and a lower surface configured to be oriented toward the ground when the horse is standing, with the hoof 1154 being placed as shown in FIG. 5 in a working configuration. The base 2060 is attached to and supports, by way of the legs 2080, a shoe rail 2010. The shoe rail 2010, which in form is comparable to a horseshoe and may be a conventional, commercially available horseshoe of aluminum or other standard or suitable construction, is attached to the upwardly extending legs 2080 of the base 2060. The shoe rail 2010 thus includes holes for horseshoe nails in the manner of a conventional horseshoe and clips 2012, which help to locate and stabilize the shoe rail 2010—and more generally, the second therapeutic horseshoe 2000, on the hoof 1154 of a horse.

The second therapeutic horseshoe 2000 includes a compression plate in the form of a centrally extending protrusion 2020 configured to support a frog portion or other suitable portion of the hoof 1154. The centrally extending protrusion 2020 is pivotably or rotatably supported with respect to the shoe rail 2010 by a shaft 2024. The shaft 2024 may have end elements 2040 to assist in the retention thereof. In the illustrated embodiment, the shaft 2024 is supported by collars 2028 that are attached to and supported by a lower surface of the shoe rail 2010.

The centrally extending protrusion 2020 is supported in a manner providing a driving force to propel the centrally extending protrusion 2020 upwardly to provide and maintain force and pressure on the frog 1156 of the hoof 1154. Note that although the centrally extending protrusion 2020 is shown quite far above the shoe rail 2010 in FIG. 5, in use the centrally extending protrusion 2020 will be closer to the plane of the upper surface of the shoe rail 2010, as indicated by the directional arrow 2021 (FIG. 5). A resilient member may be disposed between the base 2060 and centrally extending protrusion 2020 to provide the necessary force. As shown, the resilient member is a spring 2100 disposed between the centrally extending protrusion 2020 and the base 2060. Alternatively, the resilient member may include an inflatable cushion, a portion of resilient material, a hydraulic device such as a small hydraulic cylinder, or an air spring. The resilient member may optionally have adjustable resiliency. For example, the spring 2100 may be disposed between a lower locator plate 2140 and an upper locator plate 2142. A stabilizer protrusion in the form of a stabilizer bolt 2160 may engage the lower locator plate 2140 to prevent unwanted rotation of the lower locator plate 2140. The stabilizer bolt 2160 may engage an interior body such as an interior plate 2162 of the base 2160 and may be secured thereto by nuts 2150. An adjustment nut 2120 optionally may be engageable with an adjustment bolt 2122 to compress the spring 2100 to modify the force provided by the spring 2100. The adjustment bolt 2122 may bass through the interior plate 2162 of the base 2160 and may extend through the base 2160 to a head 2124. The adjustment bolt may be secured loosely with respect to the interior plate 2162 by a nut 2126 to limit relative axial movement thereof while allowing some rotation of the adjustment bolt 2122. Rotation of the adjustment bolt 2122 pulls the adjustment nut 2120 toward the base 2160 to compress the spring 2100.

In one aspect, a method of treating laminitis of a hoof 1154 of a horse 1150 includes applying a force or pressure to the hoof 1154, particularly to a lower surface thereof, including but not limited to the frog 1156 thereof, with the force or pressure being sustained or increased over time. Prior methods apply a force to a hoof 1154 as a treatment for laminitis—but in prior methods, contrary to the presently disclosed method, the applied force or pressure decreases over time due to compression of the apparatus used to treat the hoof 1154, as well as due to growth of the hoof 1154 and deformation of the hoof 1154. Maintaining and increasing pressure on the hoof 1154, especially increasing pressure on the hoof over time, provides a superior and unexpected result compared to prior methods of treating laminitis.

Methods of treading laminitis of a hoof 1154 of a leg 1152 of a horse 1150 may include attaching a therapeutic horseshoe 1100 or a second therapeutic horseshoe 2000 (as described above) to the hoof 1154. The method includes attaching the front base plate 1110 and the shoe rail 1116 to the hoof 1154 using conventional techniques employing horseshoe nails. The front support element 1200, including the bridge 1190, is then assembled by securing the spacers 1202 between the front base plate 1110 and the bridge link 1192 using the bolts 1204 and the nuts 1205, with the front transverse link 1206 disposed between the front base plate 1110 and the spacers 1202. This securing step is performed for each bridge 1190 on each side of the hoof 1154 (with a bridge 1190 on each lateral side of the hoof 1154). The rear support element 1220 is assembled by securing the springs 1222 between the bridge link 1192 and the rear base plate 1130 using the bolts 1224, the nuts 1225, and the spacers 1227 and the auxiliary tying plate 1300 where used, with the rear transverse link 1226 disposed between the rear base plate 1130 and the springs 1222. The compressive stiffness of the rear support element 1220 may be selected by applying a selected degree of compression to the springs 1222 by tightening the bolts 1224. During treatment of laminitis of the hoof 1154, the degree of compression of the springs 1222 may be initially set to a low level providing a relatively low compressive stiffness, and then may be progressively adjusted for either essentially constant stiffness or increasing stiffness as the hoof 1154 heals and the frog 1156 becomes less inflamed and less sensitive, with the result that the hoof 1154 is subjected to constant or increasing pressure during the treatment process. Preferably, during treatment of laminitis of the hoof 1154, the degree of compression of the springs 1222 may be initially set to a low level providing a relatively low compressive stiffness, and then may be progressively adjusted for at least steady and preferably increasing stiffness as the hoof 1154 heals and the frog 1156 becomes less inflamed and less sensitive.

In use, a method of treating laminitis of a hoof 1154 of a horse 1150 may include attaching therapeutic horseshoe 1100 of a second therapeutic horseshoe 1100 hoof 1154 of a leg 1152 of a horse 1150; the hoof 1154 is the hoof 1154 that is initially afflicted with laminitis. The method includes attaching the front base plate 1110 and the shoe rail 1116 to the hoof 1154 using conventional techniques employing horseshoe nails. The front support element 1200, including the bridge 1190, is then assembled by securing the spacers 1202 between the front base plate 1110 and the bridge link 1192 using the bolts 1204 and the nuts 1205, with the front transverse link 1206 disposed between the front base plate 1110 and the spacers 1202. This securing step is performed for each bridge 1190 on each side of the hoof 1154 (with a bridge 1190 on each lateral side of the hoof 1154). The rear support element 1220 is assembled by securing the springs 1222 between the bridge link 1192 and the rear base plate 1130 using the bolts 1224, the nuts 1225, and the spacers 1227 where used, with the rear transverse link 1226 disposed between the rear base plate 1130 and the springs 1222. The compressive stiffness of the rear support element 1220 may be selected by applying a selected degree of compression to the springs 1222 by tightening the bolts 1224. During treatment of laminitis of the hoof 1154, the degree of compression of the springs 1222 may be initially set to a low level providing a relatively low compressive stiffness, and then may be progressively adjusted for greater stiffness or reduced stiffness as the hoof 1154 heals and the frog 1156 becomes less inflamed and less sensitive.

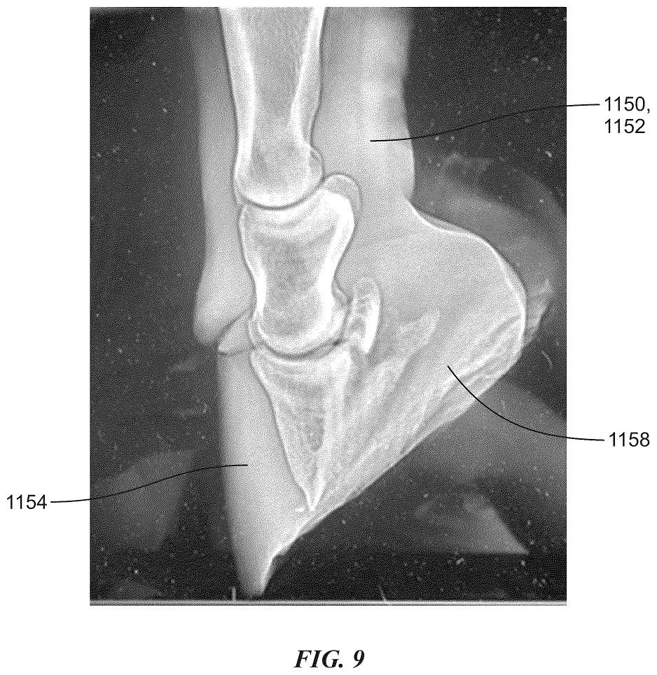

A formable insert 1244 may be inserted between (a) the rear base plate 1130, the front base plate 1110, or the auxiliary tying plate 1300 (where present) and (b) the hoof 1154 or the frog 1156 or the digital cushion 1158 (FIG. 9). The formable insert 1244 may be formed and inserted as follows. The bolts 1224 that tighten the springs 1222 may be left loose, and the spacers 1227 may initially be omitted is order to allow space for insertion of the formable insert 1244. The formable insert 1244 may be formed using a suitable castable material, such as a roll (3in x 4 yard) of castable material such as orthopedic casting tape (for example, such a tape provided by Jorgensen Laboratories, CO) of fiberglass. Such orthopedic casting tape may be used in the formable insert 1244, with the formable insert 1244 being presently used in a preferred method of applying long-term frog pressure. The orthopedic casting tape is advantageous in being a porous material that prevents too much accumulation of moisture over the frog 1156 of the hoof 1154. A drier frog 1156 is harder and maintains its shape, which is advantageous for the purpose of methods and devices disclosed herein). The formable insert may be formed from such casting material, impression material, or other formable material that may be curable into a fixed or relatively fixed resilient shape. The casting tape or other suitable castable material may be shaped to fit the area of the frog 1156 of the hoof 1154. Once the desired shape is made to confirm with the anatomy of the hoof 1154, the castable material is submerged in water to begin the hardening process. Before hardening occurs, the castable material is placed between the hoof 1154 and the rear base plate 1130, the front base plate 1110, or the auxiliary tying plate 1300, and the bolts 1224 are tightened. The thickness of the formable insert 1244 may preferably be selected be such that the rear base plate 1130 is about 5 mm lower than the front plate 1110, before pressure is applied by the weight of the horse 1150. The hoof 1154 is then set on the ground to allow the weight of the leg with the hoof 1154 to compress and shape the formable insert 1244 before the formable insert 1244 fully hardens. Once the hardening process has finished, the bolts 1224 may be removed one by one, the spacers 1227 may be inserted one by one, and the bolts 1224 may then tightened with a wrench evenly or essentially evenly, with the bridge link 1192 and the rear transverse link 1226 remaining aligned essentially in parallel, with an essentially even gap therebetween. The result of this arrangement places pressure on the hoof 1154 and in particular on the frog 1156 and/or the digital cushion 1158 and/or the clefts of the hoof 1154. If the hoof 1154 collapses due to damage, the therapeutic horseshoe 1100 or the second therapeutic horseshoe 2000 may be connected to the heel of the hoof 1154 rather than to the toe of the hoof 1154. The therapeutic horseshoe therapeutic horseshoe 1100 or the second therapeutic horseshoe 2000 may optionally incorporate a pressure-measuring device such as a strain gage, pressure-sensitive film, or comparable measuring device to track the stress or force imposed by the therapeutic horseshoe 1100 or the second therapeutic horseshoe 2000. The measuring device may be connectable via a wired or wireless network to a storage unit (including a computer or a smart phone) configured to receive and/or store and/or interpret the measurements.

Alternatively, a second therapeutic horseshoe 2000 may be employed in a similar fashion. The shoe rail 2010 is secured to the hoof 1154. The centrally extending protrusion 2020 exerts force on the frog 1156 by way of the spring 2100 or other biasing element if present. The force or compressibility of the spring may be adjusted using the adjustment nut 2120 to engage the adjustment bolt 2122. A formable insert 1244 may be placed between the centrally extending protrusion 2020 and the frog 1156.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present disclosure.

I claim:

1. A therapeutic horseshoe configured to be mounted on a hoof of a horse for treating laminitis of the hoof, the therapeutic horseshoe comprising:
a shoe rail configured to be secured to the hoof;
a compression plate configured to engage a frog portion of the hoof; and
a biasing element disposed to urge the compression plate to exert pressure on the frog portion of the hoof.

2. The therapeutic horseshoe of claim 1, further comprising a base having an upper surface configured to face the hoof and a lower surface configured to face opposite the hoof, the base including a plurality of upwardly extending legs.

3. The therapeutic horseshoe of claim 2, wherein the shoe rail is supported by and attached to the upwardly extending legs of the base, the shoe rail including nail holes configured to receive horseshoe nails for securing the therapeutic horseshoe to the hoof.

4. The therapeutic horseshoe of claim 2, wherein the compression plate comprises a centrally extending protrusion configured to support a frog portion of the hoof.

5. The therapeutic horseshoe of claim 4, wherein the centrally extending protrusion is pivotably supported relative to the shoe rail by a shaft attached to the protrusion, the shaft being pivotably attached to the shoe rail.

6. The therapeutic horseshoe of claim 4, wherein the biasing element comprises a resilient member disposed between the centrally extending protrusion and the base to urge the centrally extending protrusion upwardly toward the frog portion of the hoof.

7. The therapeutic horseshoe of claim 6, wherein the resilient member comprises a spring disposed between a lower locator plate and an upper locator plate.

8. The therapeutic horseshoe of claim 7, further comprising an adjustment member engageable to compress the spring to selectively vary a force applied by the centrally extending protrusion to the frog portion of the hoof during treatment of laminitis.

9. The therapeutic horseshoe of claim 1, further comprising:
a front base plate having an upper surface configured to engage an underside of a hoof wall and a lower surface configured to face a ground surface;
a rear base plate disposed posteriorly of the front base plate and having an upper surface defining at least a portion of the compression plate and configured to engage the frog portion of the hoof, and a lower surface configured to face the ground surface; and
a bridge linking the front base plate to the rear base plate, wherein the shoe rail is secured to the front base plate and the rear base plate and extends between the front base plate and the rear base plate.

10. The therapeutic horseshoe of claim 9, further comprising:
a front support element disposed between the bridge and the front base plate and having a first compressive stiffness; and
a rear support element disposed between the bridge and the rear base plate and defining the biasing element,
wherein the rear support element has a second compressive stiffness lower than the first compressive stiffness to apply a controlled force to the frog portion of the hoof.

11. The therapeutic horseshoe of claim 10, wherein:
the front support element comprises a pair of tubular steel spacers; and
the rear support element comprises at least one spring adjustable in compression to selectively vary the controlled force applied to the frog portion of the hoof during a course of treatment.

12. The therapeutic horseshoe of claim 11, wherein the rear support element comprises a pair of coil springs, each coil spring being preloaded by an adjustable threaded fastener.

13. The therapeutic horseshoe of claim 10, wherein the rear base plate includes a centrally extending protrusion configured to support the frog portion of the hoof.

14. The therapeutic horseshoe of claim 10, further comprising a deformable ground base attached to the lower surface of the rear base plate, the deformable ground base including:
a base dish; and
a resilient bushing disposed between the base dish and the rear base plate.

15. The therapeutic horseshoe of claim 10, wherein the bridge includes:
a horizontal portion extending parallel to the upper surfaces of the front base plate and the rear base plate; and
a transverse backing portion disposed proximally relative to the hoof.
